(19) United States
(12) Patent Application Publication
(10) Pub. No.: US 2015/0106269 A1
(43) Pub. Date: Apr. 16, 2015

(54) METHOD OF PAYMENT BETWEEN PLURALITY OF USERS IN DISTRIBUTED NETWORK SYSTEM USING TOKENS

(71) Applicant: Sumana Krishnaiahsetty BATCHU, (US)

(72) Inventor: Sumana Batchu Krishnaiahsetty, Bangalore (IN)

(21) Appl. No.: 14/403,139

(22) PCT Filed: May 24, 2013
(86) PCT No.: PCT/IB2013/054303

§ 371 Date: Nov. 21, 2014

(30) Foreign Application Priority Data
May 24, 2012 (GB) 1209168.2

(51) Int. Cl. G06Q 20/06; G06Q 20/24

(52) U.S. Cl. CPC G06Q 20/0655; G06Q 20/24
USPC 705/44

(57) ABSTRACT

Embodiments of the present disclosure relate to method and a system for payment between plurality of users using tokens in a distributed networking system. The method involves configuring a token account for each transacting user of the distributed networking system. In a transaction between users, the consumer obtaining service from the provider should provide predefined number of tokens for the obtained service. The predefined number of tokens is transferred from the token account of the consumer to the token account of the provider. If there is non-availability of the predefined number of tokens to perform the transaction in the token account of the consumer, the transaction server in the distributed networking system allows the transaction only if the consumer account is still within the defined credit limit after paying the predefined number of tokens from the consumer account.

### BACKGROUND

1. Technical Field

The present disclosure relates to a distributed networking system. In particular, the present disclosure relates to a method of payment between the plurality of users in the distributed network system using virtual currency referred to as tokens.

2. Description of the Related Art

Information plays an increasingly important role in the lives of people and businesses. Internet service providers are spending enormous amounts of money and resources in infrastructure to facilitate bringing more businesses online as it is more convenient and saves time. The Internet service providers host many websites wherein each website is configured to provide one or more services to the customers. For each service provided by the website, the customer is required to pay for the service. The money paid by the customer over the internet is referred as electronic money.

In certain cases, the electronic money could actually be virtual money, and is usually sold by the website, or awarded by the website to the customers of the website for performing various actions like completion of a stage in a game for making purchases and so on. Using such virtual money for transactions has the benefit of reduced risk and reduced cost of transaction. Awarding virtual money by websites also promotes loyalty. However, the virtual money can typically be used only in transactions with the website like purchasing in-game accessories, game-upgrades, etc. In all these, the website is incurring a cost, although insignificant in most cases.

In order to benefit from the use of virtual money transactions, while reducing the costs for the website involved in awarding the virtual money to the users, the present disclosure presents a system and associated methods to facilitate virtual money transactions.

### SUMMARY

The shortcomings of the prior art are overcome and many additional advantages are provided through the present disclosure. Additional features and advantages are realized through the techniques of the present disclosure. Other embodiments and aspects of the disclosure are described in detail herein and are considered a part of the claimed disclosure.

In one embodiment, the present disclosure provides a method of payment between plurality of users in a distributed networking environment using virtual money, referred to as tokens henceforth. The method comprises determining one or more users involved in a transaction by a processing unit of a transaction server, where each user is associated with a token account and the token account is stored in a storage unit of the transaction server. Upon determining the one or more users involved in the transaction, the processing unit retrieves value of the transaction and predefined number of tokens associated with the retrieved value of the transaction. The transaction users are identified as at least one of a consumer and a provider. After retrieving the value of the transaction and the predefined number of token associated with the retrieved value of the transaction, the processing unit validates the token account of the consumer to transfer the payment to the provider. The token account of the consumer is validated to check if balance number of tokens available in the token account of the consumer is within the credit-limit defined by the transaction server after paying the predefined number of tokens associated with the retrieved value of the transaction from the account. Upon successfully validating the token account of the consumer, the processing unit transfers the predefined number of tokens associated with the retrieved value of the transaction from the token account of the consumer to the token account of the provider. The payment system further includes a provision to reverse a payment transaction to be used in case of a cancelled transaction. Cancellation of a transaction might be necessary in the event of damaged goods, lost goods, returned goods, etc.

In one embodiment, the transaction server charges the user of the distributed networking system a commission, either in real money or in tokens, based on the number of tokens transacted by the user. In another embodiment, the transaction server could impose a subscription fee on the users for availing the facility to use token transactions.

In one embodiment, the present disclosure provides a system for payment between plurality of users in a distributed networking environment using tokens. The system comprises a transaction server connected to a plurality of client devices, associated with the plurality of users, over a network. The transaction server comprises a processing unit and a storage unit in communication with the processing unit. The processing unit configures token account for each user in the distributed networking system. The token account of each user is stored in the storage unit. Upon determining the one or more users involved in the transaction the processing unit retrieves value of the transaction and predefined number of tokens associated with the retrieved value of the transaction. The processing unit then identifies the one or more users involved in the transaction as at least one of a consumer and a provider. The predefined number of token associated with the retrieved value of the transaction is used by the processing unit to validate the token account of the consumer is within the specified credit limit defined by the distributed networking system, where the credit-limit could even be a negative value. Upon successfully validating the token account of the consumer, the processing unit transfers the predefined number of tokens associated with the retrieved value of the transaction from the token account of the consumer to the token account of the provider.

The aforementioned and other features and advantages of the disclosure will become further apparent from the following detailed description of the presently preferred embodiments, read in conjunction with the accompanying drawings. The detailed description and drawings are merely illustrative of the disclosure rather than limiting, the scope of the disclosure being defined by the appended claims and equivalents thereof.

### BRIEF DESCRIPTION OF THE DRAWINGS

The features of the present disclosure are set forth with particularity in the appended claims. The embodiments of the disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 illustrates a distributed networking system in accordance with an embodiment of the present disclosure; and

FIG. 2 shows a flow-chart illustrating a method of payment between plurality of users in a distributed networking system using tokens in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF PREFERRED EMBODIMENTS

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

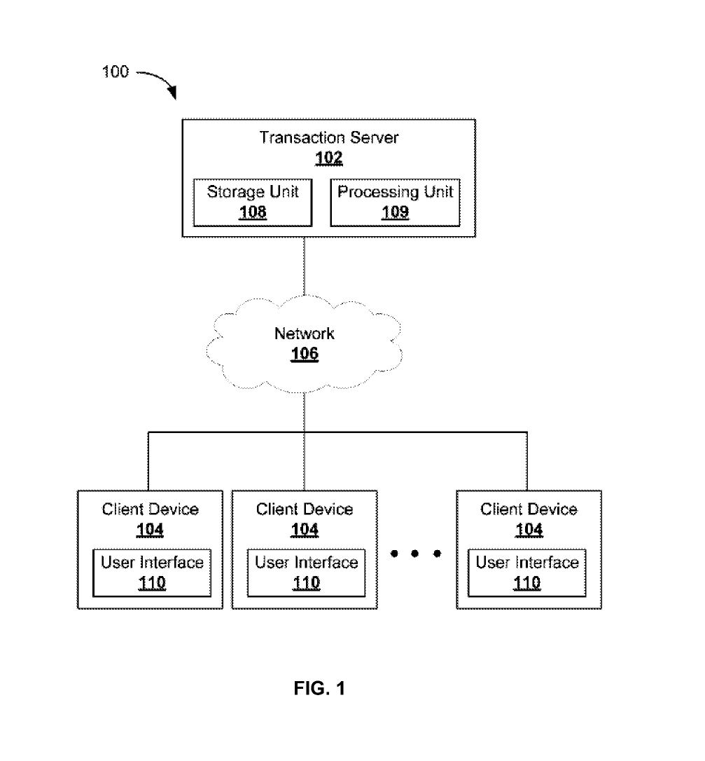

FIG. 1 illustrates a distributed networking system 100 in accordance with an embodiment of the present disclosure. In an embodiment, the distributed networking system 100 is an eCommerce website that supports at least one of customer to customer (C2C) transactions and business to customer (B2C) transactions. The system 100 comprises a transaction server 102, a plurality of client devices 104 and a network 106 connecting the transaction server 102 to the plurality of client devices 104. The transaction server 102 comprises a storage unit 108 and a processing unit 109. The client device 104 comprises a user interface 110. The user interface 110 is configured to input information from the one or more users connected over the network 106. Also the user interface 110 is configured to display one or more information. The client device 104 is selected from at least one mobile phone, a personal computer, portable computer, a personal digital assistant (PDA), netbooks, tablet, iPad, electronic reader and any other computing device capable of receiving and transmitting information over the network 106. The client device 104 is associated with a user carrying out transaction in the distributed networking system 100.

For each user in the distributed networking system 100, the processing unit 109 creates a token account. In an embodiment, the processing unit 109 creates the token account upon receiving a predefined amount of real money from the user. The token account comprises name of the user, account number and a password. The token account associated with each user is stored in the storage unit 108. In one embodiment, upon creating the token account, the transaction server 102 provides a preconfigured number of tokens to the user, which is deposited in the token account of the user. In another embodiment, the transaction server allows payments to be made even when the balance number of tokens in any of the transacting accounts is zero, so long as the new balance of the consumer account after effecting the transaction is within the specified credit-limit. The tokens are a form of virtual cash created by the transaction server 102 to enable the users to transact among themselves and with the transaction server 102.

In an embodiment, the one or more users sell their offline services and items/goods for the tokens. The user receiving the service is referred as a consumer and the user providing the service is referred as the provider. Upon receiving the service from the provider, the consumer provides the predefined number of tokens to the provider as agreed upon by the consumer and the provider. The processing unit 109 transfers the predefined number of tokens from the token account of the consumer to the token account of the provider. The processing unit 109 updates the token account of both the provider and the consumer whenever a transaction is carried out between the consumer and the provider. Token payments can be made for a variety of transactions where payments can either be post-paid, pre-paid or split-paid, wherein part of the amount is paid prior to the transaction and part of it after the transaction. If the consumer is not satisfied with the received goods or services, if the requested goods and services are not received within time or if the consumer returns the received goods, then the consumer requests for reverse transaction. At this stage, the processing unit 109 forwards the request to the provider. When the provider agrees for the reverse transaction, the processor performs the reverse transaction process by transferring the predefined number of tokens form the providers account back to the consumer account. The processing unit 109 updates the reverse transaction details in the transaction log stored in the storage unit 108.

In one embodiment, instead of providing the predefined number of tokens to the provider, the consumer provides any other service to the provider at any time as agreed upon by the consumer and the provider. In one embodiment, a user purchases predefined number of tokens from another user or even from the transaction server 102 for real money. The predefined number of tokens can also be transferred from one user to another user in the distributed networking system 100 for the purpose of gifting, offline transaction or for real cash. Such a transfer transaction will have a provision to attach a description to the transfer transaction.

In one embodiment, where the users are allowed to make token payments even when the balance is zero, the outstanding token balance could be a negative value at any given time. In such a case, at the time of termination of the token account, the user has to pay real money for the negative number of tokens in the token account. The processing unit 109 performs validation of the token account of the consumer to ensure it is within the specified credit-limit before allowing the transaction between the consumer and the provider and between the consumer and any other affiliate stores. The affiliate stores are the online stores which provide one or more services and goods. To replenish balance of tokens in a token account for performing the transactions, the user has to obtain the tokens in the distributed networking system 100 either by providing one or more services or goods to other users in the network or by buying the tokens from the other users or from the transaction server 102 by paying real money. In one embodiment, the obtained tokens are redeemable by buying any goods or services like apps, games, ebooks, music etc. from the transaction server 102.

The storage unit 108 stores the token account of each user in the distributed networking system 100. The processing unit 109 maintains a transaction log of each transfer of predefined number of tokens between one or more users. The transaction log is stored in the storage unit 108. The transaction log also stores transaction ID of the one or more users.

In an embodiment, the present disclosure provides an option to redeem the predefined number of tokens against any transaction made offline in the one or more affiliate establishments. For example, the establishment could be any shop in which the user buys goods. To pay for a transaction at the affiliate store, the user could use a client device such as a mobile device with a wallet application. The wallet application is an application which supports secure payments for transactions between the user and the establishment. Using the wallet application the user pays/redeems the predefined number of tokens against any transaction made between the user and the one or more establishments. In one embodiment, the token account number of the establishment is available as a barcode and the wallet application configured in the client device is provided with a scanner interface. If the user purchases any good from any establishment, the user scans the barcode provided by the establishment to retrieve the token account number of the establishment. Upon retrieving the token account number, the user transfers the predefined number of tokens associated with the good to the establishment.

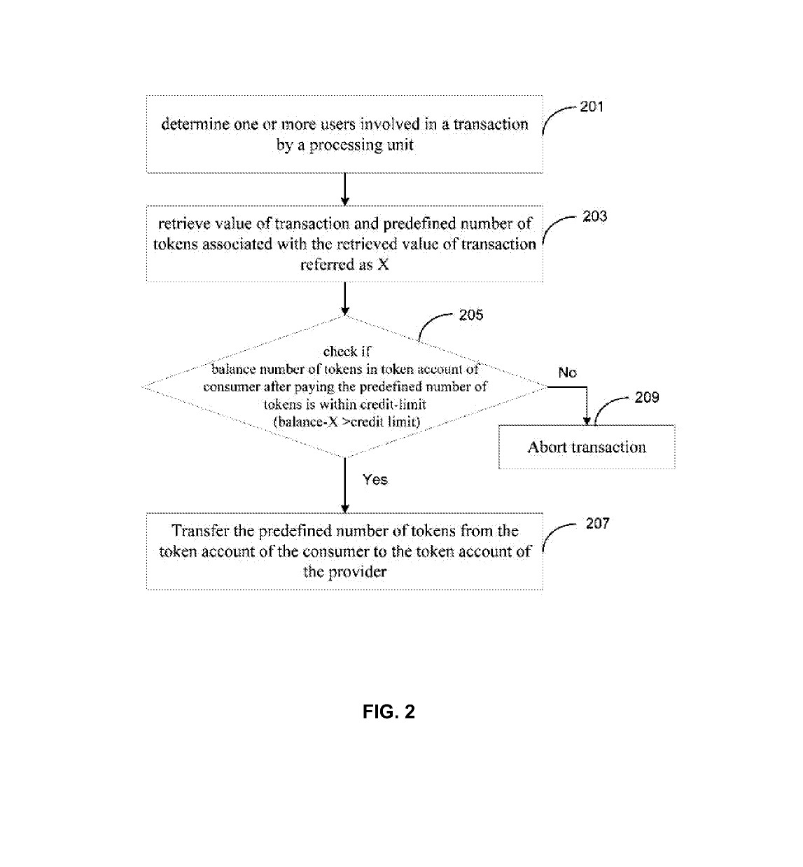

FIG. 2 shows a flow-chart illustrating a method for transaction between plurality of users in a distributed networking system in accordance with an embodiment of the present disclosure. At step 201, the processing unit 109 configured in the transaction server 102 determines one or more users involved in a transaction. For each user, the processing unit 109 configures a token account at the time of enrolment or subscription. The token account consists of username, account number, account balance in tokens and password. The user providing service is referred as a provider and the user obtaining the service or the goods is referred as consumer. The processing unit 109 retrieves the value of the transaction at step 203. The processing unit 109 also retrieves the predefined number of tokens associated with the retrieved value of the transaction. The predefined number of tokens associated with the retrieved value of the transaction is referred as X. At step 205, the processing unit 109 validates the token account of the consumer to make the payment to the provider. The validation involves checking that balance number of tokens in the token account of the consumer is within the credit limit defined by the transaction server 102. i.e. balance −X should be greater than the credit limit. Upon successful validation of the token account of the consumer, the processing unit 109 transfers the predefined number of tokens associated with the retrieved value of the transaction from the token account of the consumer to the token account of the provider at step 207. In case of unsuccessful validation, the processing unit 109 aborts the transaction at step 209.

In an exemplary embodiment, the transaction is between the one or more users i.e. C2C transaction of the distributed networking system 100. Three users namely a first user, a second user and a third user are involved in the transaction in the distributed networking system 100. The three users communicate with the transaction server 102 through the network 106 using their respective client devices 104. The token accounts of the users consists of name of the user, account number, account balance in tokens and password as shown in the below Table 1.

TABLE 1

| | | Token Account | | Number of |
|---|---|---|---|---|
| Number of users | User name | number | Password | tokens |
| 1 | ABC | 123 | **** | 0 |
| 2 | XYZ | 345 | ****** | 200 |
| 3 | EFG | 567 | ****** | 300 |

For example, the first user needs music lessons from the second user. The first user requests the second user to provide the music lessons for the predefined number of tokens as agreed upon between the first user and the second user. For example, the second user agrees to provide the music lessons to the first user for 50 tokens. The processing unit 109 records the value for the requested service by the first user. The processing unit 109 validates the token account of the first user to check if the balance available in the token account after making payment to the second user is within a specified credit limit. In this scenario, let's assume that the defined credit limit for the first user is −100 tokens. If the first user makes the payment for the music lesson transaction, it results in the new balance after the transaction of −50 which is more than −100, the defined credit-limit. Therefore, the processing unit 109 allows the transaction between the first user and the second user. The token account at the end of the above transaction as updated by the processing unit 109 is shown in the below Table 2.

TABLE 2

| | | Token Account | | Number of |
|---|---|---|---|---|
| Number of users | User name | number | Password | tokens |
| 1 | ABC | 123 | **** | −50 |
| 2 | XYZ | 345 | ****** | 250 |
| 3 | EFG | 567 | ****** | 300 |

With the new account balance of −50 tokens, the first user cannot obtain any other service of value greater than 50 tokens in the distributed networking system 100 from any other user since there are insufficient tokens in his account. The first user however could earn additional tokens by providing one or more services or goods to other users connected to the network. In one embodiment, the first user can also purchase the tokens by paying real money to the transaction server 102.

In another exemplary embodiment, the transaction is between an individual user and the transaction server 102 of any affiliate store. The affiliate store offers one or more services and one or more goods. The affiliate store and the user are configured with the token account. The user obtains a service form the affiliate store. Upon obtaining the service from the affiliate store, the processing unit 109 transfers the predefined number of tokens associated with the service to the token account of the affiliate store. This is a form of redemption of tokens by the individual user.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral numerals:

| Description | Reference Number |
|---|---|
| Distributed Networking | 100 |
| System | |
| Transaction server | 102 |
| Storage unit | 108 |
| Processing unit | 109 |
| network | 106 |
| Client device | 104 |
| User interface | 110 |

I/We claim:

1. A method of payment between plurality of users in a distributed networking system using tokens comprising:
determining one or more users involved in a transaction by a processing unit of a transaction server, wherein the determined one or more users is associated with a token account, said token account is stored in a storage unit of the transaction server;
retrieving value of the transaction and predefined number of tokens associated with the retrieved value of the transaction wherein the transaction is between the one or more users and the one or more users are at least one of a consumer and a provider;
validating the token account of the consumer by the processing unit to transfer the payment to the provider, wherein the token account of the consumer is validated to check if balance number of tokens available in the token account of the consumer after paying the predefined number of tokens is within a credit-limit specified by the transaction server; and
transferring the predefined number of tokens associated with the retrieved value of the transaction from the token account of the consumer to the token account of the provider by the processing unit upon validation.

2. The method as claimed in claim 1, wherein the predefined number of tokens associated with the retrieved value of the transaction is transferred back from the account of the provider to the account of the consumer by the processing unit when the transaction between the consumer and the provider is cancelled.

3. The method as claimed in claim 1 further comprising storing transaction log of each transfer of predefined number of tokens between the one or more users in the storage unit

4. The method as claimed in claim 1, wherein the distributed networking system is an eCommerce website that supports at least one of customer to customer (C2C) transactions and business to customer (B2C) transactions.

5. The method as claimed in claim 1 further comprises transferring predefined number of tokens from the token account of one user to the token account of another user for a purpose selected from at least one of gifting, offline transaction and exchange for real money.

6. The method as claimed in claim 1, wherein the user obtains real money by selling the tokens to at least one of the transaction server and another user in the distributed networking system.

7. The method as claimed in claim 1, where the user purchases tokens for real money from at least one of the transaction server and another user in the distributed networking system.

8. The method as claimed in claim 1, wherein the predefined number of tokens is also redeemable at one or more establishments connected to the distributed networking system when the transaction is between the one or more users and the one or more establishments.

9. The method as claimed in claim 1, wherein the credit limit specified by the transaction server allows a negative value in the token account balance.

10. The method as claimed in claim 1 further comprises charging commission to users by the transaction server in at least one of real money and tokens based on the number of tokens traded by the user.

11. A distributed networking system for making payment between plurality of users using tokens comprising:
a transaction server connected to a plurality of client devices, associated with the plurality of users, over a network comprising:
a processing unit configured to:
determine one or more users involved in a transaction, wherein the determined one or more users is associated with a token account, said token account is stored in a storage unit of the transaction server;
retrieve value of the transaction and predefined number of tokens associated with the retrieved value of the transaction, wherein the transaction is between the one or more users and the one or more users are at least one of a consumer and a provider;
validate the token account of the consumer to transfer the payment to the provider, wherein the token account of the consumer is validated to check if balance number of tokens available in the token account of the consumer after debiting the predefined number of tokens is within a credit-limit specified by the transaction server; and
transfer the predefined number of tokens associated with the retrieved value of the transaction from the token account of the consumer to the token account of the provider upon validation.

12. The system as claimed in claim 11, wherein the client device is selected from at least one of a mobile phone, a personal computer, laptop, a personal digital assistant (PDA) and any other computing device.

13. The system as claimed in claim 11, wherein the client device comprises a wallet application to securely access the token account information over the network.

14. The system as claimed in claim 11, wherein the client device identifies the token account in a transfer transaction by scanning a barcode that encodes the token account information.

15. The system as claimed in claim 11, wherein the storage unit stores transaction log of each transfer of predefined number of tokens between the one or more users.

16. The system as claimed in claim 11, wherein the distributed networking system is an eCommerce website that supports at least one of customer to customer (C2C) transactions and business to customer (B2C) transactions.
